(19) United States
(12) Patent Application Publication
(10) Pub. No.: US 2013/0185477 A1
(43) Pub. Date: Jul. 18, 2013

(54) VARIABLE LATENCY MEMORY DELAY IMPLEMENTATION

(71) Applicants: Victor A. Acuña, Rochester, MN (US); Dale L. Elson, Round Rock, TX (US); Mark J. Hickey, Rochester, MN (US); Galen A. Lyle, Fort Collins, CO (US); Ibrahim A. Ouda, Rochester, MN (US)

(72) Inventors: Victor A. Acuña, Rochester, MN (US); Dale L. Elson, Round Rock, TX (US); Mark J. Hickey, Rochester, MN (US); Galen A. Lyle, Fort Collins, CO (US); Ibrahim A. Ouda, Rochester, MN (US)

(73) Assignee: INTERNATIONAL BUSINESS MACHINES CORPORATION, Armonk, NY (US)

(21) Appl. No.: 13/352,619

(22) Filed: Jan. 18, 2012

(51) Int. Cl. G06F 12/00

(52) U.S. Cl. 711/103; 711/167; 711/105; 711/E12.008

(57) ABSTRACT

A method includes receiving, from a processor, a first read request mapped including a first read request address to a first memory location of a register array and a second read request including a second read request address to a second memory location of a register array. The method includes assigning a first simulated time delay to the first read request and assigning a second simulated time delay to the second read request. The method includes, in response to a first elapsed time being equal to the first simulated time delay, outputting a first read request response including first data. The first elapsed time commences upon receipt of the first read request. The method includes, in response to a second elapsed time being equal to the second simulated time delay, outputting a second read request response including second data. The second elapsed time commences upon receipt of the second read request.

### I. FIELD OF THE DISCLOSURE

The present disclosure relates generally to field programmable gate arrays and particularly to memory access.

### II. BACKGROUND

Existing testing of processor functionality involves design, layout and fabrication of a printed circuit board including the traces necessary to communicate with various devices. A processor that is designed to interface with many distinct memory architectures may require several printed circuit board designs to accommodate the various memory architectures. The process of designing, laying out, and fabricating a new printed circuit board may be time and labor intensive, and may lead to development delays.

### III. SUMMARY

According to a particular embodiment, a method includes receiving a first read request from a processor. The first read request includes a first read request address mapped to a first memory location of a register array. The method further includes receiving a second read request from the processor. The second read request includes a second read request address mapped to a second memory location of the register array. The method further includes assigning a first simulated time delay to the first read request and assigning a second simulated time delay to the second read request. The method further includes, in response to a first elapsed time being equal to the first simulated time delay, outputting a first read request response. The first read request response includes first data stored at the first memory location. The first elapsed time commences upon receipt of the first read request. The method further includes, in response to a second elapsed time being equal to the second simulated time delay, outputting a second read request response. The second read request response includes second data stored at the second memory location. The second elapsed time commences upon receipt of the second read request.

According to another embodiment, a semiconductor device includes a receive first-in-first-out (FIFO) buffer. The FIFO buffer is configured to receive instructions from a processor. The semiconductor device further includes a register array memory. The register array memory is configured to store first data at a first memory location and to store second data at a second memory location. The semiconductor device further includes a read request address register. The read request address register is configured to store a first read request address that is mapped to the first memory location and that is associated with a first read request received from the processor. The read request register is further configured to store a second read request address that is mapped to the second memory location and that is associated with a second read request received from the processor. The semiconductor device further includes an out-of-order controller. The out-of-order controller configured to assign a first simulated time delay to the first read request and assign a second simulated time delay to the second read request. The out-of-order controller is further configured to initiate execution of the first read request in response to first elapsed time being equal to the first simulated time delay. The first elapsed time commences upon receipt of the first read request. The out-of-order controller is further configured to initiate execution of the second read request in response to second elapsed time being equal to the second simulated time delay. The second elapsed time commences upon receipt of the second read request. The semiconductor device further includes an output controller configured to provide, to the processor, a first read request response. The first read request response includes the first data. The output controller further configured to provide, for output to the processor, a second read request response. The second read request response includes the second data.

A semiconductor is disclosed having a receive first-in-first-out (FIFO) buffer for receiving instructions from a processor, a register array memory, read request address register, an out-of-order controller configured to assign simulated time delays and initiate execution of read requests, and an output controller for returning data to a processor. As compared to the complexity and time involved in the design, layout, and fabrication of a printed circuit board, the semiconductor device may enable increased flexibility of testing processor functionality against one or more memory devices having a wide variation of timing and latency characteristics by configuring the semiconductor device to simulate timing and latency characteristics of various memory devices.

These and other advantages and features that characterize embodiments of the disclosure are set forth in the claims listed below. However, for a better understanding of the disclosure, and of the advantages and objectives attained through its use, reference should be made to the drawings and to the accompanying descriptive matter in which there are described exemplary embodiments of the disclosure.

### IV. BRIEF DESCRIPTION OF THE DRAWINGS

FIG. 1 is a system diagram of a first particular embodiment of a computer system configured to simulate memory access by a processor;

FIG. 2 is a block diagram of a second particular embodiment of a computer system configured to simulate memory access by a processor;

FIG. 3 is a flow diagram of a first particular embodiment of a method of simulating read access to a memory by a processor;

FIG. 4 is a block of a first particular embodiment of a method of maintaining a read request address and transaction index lookup table;

FIG. 5 a second particular embodiment of a computer system configured to simulate memory access by a processor; and

FIG. 6 is a flow diagram of a design process used in semiconductor design, manufacture, and/or test.

### V. DETAILED DESCRIPTION

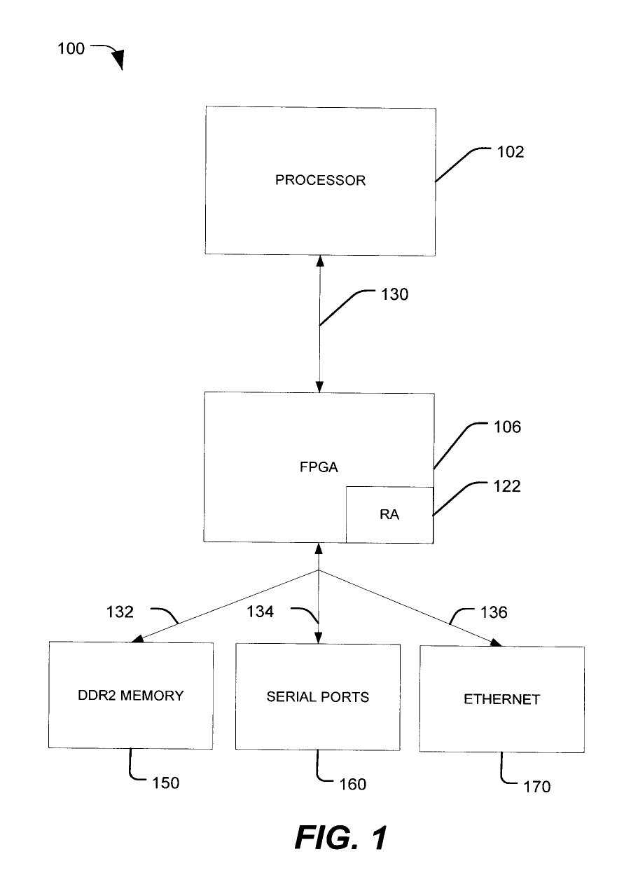

Referring to FIG. 1, a system diagram of a first particular embodiment of a computer system 100 includes a processor 102 and a field programmable gate array (FPGA) 106. The FPGA 106 may be coupled to one or more external devices, such as devices 150, 160, and 170. In an embodiment, the processor 102 interfaces with the FPGA 106 via a processor bus 130. The FPGA 106 may permit flexibility in testing the processor 102 design by simulating interaction of the processor 102 one or more memory devices. A field programmable characteristic of the FPGA 106 may permit testing simulation of multiple distinct memory configurations with relatively ease as compared to designing and laying out a distinct printed circuit board for every distinct memory configuration.

The FPGA 106 may include a register array (RA) memory 122 configured to simulate access to a memory device by the processor 102. The simulation may include receiving one or more access instructions (e.g. read or write). In an example, the FPGA 106 is configured to receive a write instruction, from the processor 102, to write data to the RA memory 122. In another example, the FPGA 106 is configured to receive a read instruction, from the processor 102, to read data from the RA memory 122. The FGPA 106 may be operable to receive a series of read requests, such as a full line cache read or a burst read. In an embodiment, the FPGA 106 includes an out-of-order (OOO) function that, when enabled, causes a series of read requests to be executed in an execution order that differs from a receiving order in which the plurality of read requests were received from the processor 102. The RA memory 122 may include memory locations having memory addresses that are addressable by the processor 102. In an embodiment, the RA memory 122 includes at least 16 addressable memory locations, each addressable memory location capable of storing at least 32 bytes.

The FPGA 106 may also communicate with external memory devices. For example, the FPGA 106 may communicate with a double data rate synchronous dynamic random access (DDR2) memory device 150 via a DDR2 interface 132, a serial port 160 device via serial port interface 134, or an Ethernet device 170 via an Ethernet interface 136. The FPGA 106 may be configured to respond to instructions from the processor 102 to communicate with any of the external devices, such as the DDR2 memory device 150, the serial port 160 device, or the Ethernet device 170.

In operation, the processor 102 may send a first instruction to the FGPA 120 via the processor bus 130. The FPGA 106 may be operable to process the first instruction. For example, when the first instruction to write first data to first RA address in the RA memory 122 is received by the FPGA 106, the FGPA 106 may process first instruction by accessing the first RA address of the RA memory 122, writing first data into the first RA address, and sending an indication of completion of the instruction to the processor 102 via the processor bus 130. In another example, when the FPGA 106 receives a second instruction to read the first data from the first RA address in the RA memory 122. The FGPA 120 processes the second instruction by accessing the first RA address of the RA memory 122, reading the first data, and sending the first data to the processor 102 via the processor bus 130.

When an OOO function is enabled, the FPGA 106 may assign a simulated time delay to each of the read requests received, and the FPGA 106 may execute a particular read request conditioned upon an elapsed time (starting at the time the read request was received by the FPGA 106) equalling the simulated time delay associated with the particular read request. Use of the simulated time delay may allow the FPGA 106 to simulate timing characteristics and latencies associated with, e.g., processing of read requests received by the FPGA 106 in a processing order that differs from an order of receipt.

The FPGA 106 may be useful in developing and testing the processor 102. The FPGA 106 may provide a simulated memory access to assist in debugging of a processor design in lieu of a full printed circuit board design, layout, and fabrication for each memory device type to be interfaced to the processor 106. The FGPA 120 may also enable a simulation of latencies and timing characteristics associated with various different memory devices by assigning a simulated time delay to each read request directed to a memory location in the RA memory 122 of the FPGA 106. The FPGA 106 may receive a series of read requests from the processor 102, and each individual read request in the series of read requests may be assigned a corresponding simulated time delay by the FPGA 106.

The FPGA 106 may include a receive first-in-first-out (FIFO) buffer configured to receive instructions from the processor 102. The FPGA 106 may also include a RA memory 122 that is configured to store first data at a first memory location and second data at a second memory location. The FPGA 106 may also include a read request address register. The read request address register may be configured to store a first read request address that is mapped to the first memory location and that is associated with the first read request received from the processor 102. The read request address register may be further configured to store a second read request address that is mapped to the second memory location and that is associated with the second read request received from the processor 102.

The FPGA 106 may further include an out-of-order (OOO) controller configured to assign a first simulated time delay to the first read request and a second simulated time delay to the second read request. The OOO controller may be further configured to initiate execution of the first read request in response to first elapsed time (commencing upon receipt of the first read request) being equal to the first simulated time delay. The OOO controller may be further configured to initiate execution of the second read request in response to second elapsed time (commencing upon receipt of the second read request) being equal to the second simulated time delay. The FPGA 106 may also include an output controller configured to provide to the processor 102 a first read request response, where the first read request response may include the first data. The output controller may be further configured to provide a second read request response, where the second read request response may include the second data. In embodiment, the first read request is received before the second read request and the first simulated time delay is larger than the second simulated time delay. In another particular embodiment, the second read request response is output prior to outputting the first read request response.

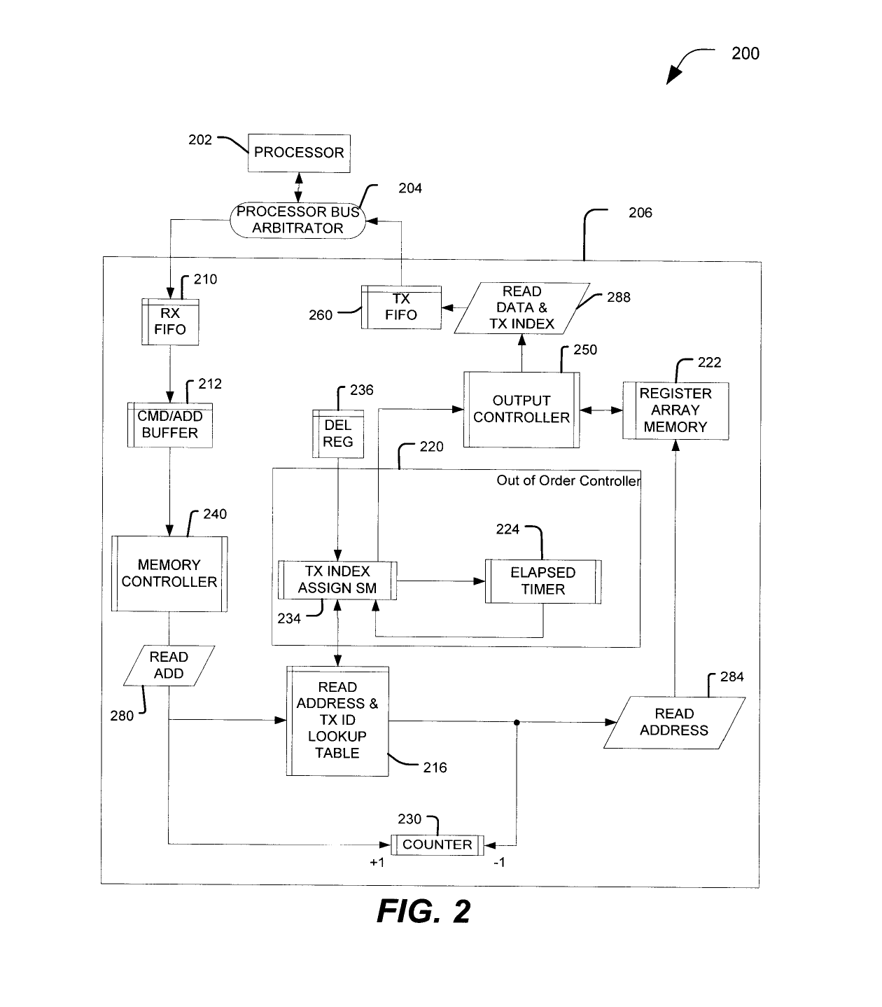

Referring to FIG. 2, a block diagram of a particular embodiment of a computer system 200, includes a field programmable gate array (FPGA) 206 configured to simulate memory access by a processor 202. The processor 202 may be coupled to a processor bus arbitrator 204. The processor bus arbitrator 204 is coupled to the FPGA 206. The processor bus arbitrator 204 may send and receive data and instructions from the processor 202, and may send and receive data from the FPGA 206. The processor 202 may correspond to the processor 102 of FIG. 1. The processor bus arbitrator 204 may correspond to a portion of the processor bus 130 of FIG. 1. The FPGA 206 may correspond to the FPGA 106 of FIG. 1. A register array (RA) memory 222 may correspond to the RA memory 122 of FIG. 1.

The FPGA 206 may receive a processor instruction via the processor bus arbitrator 204 into a receive first-in-first-out (FIFO) buffer (RX FIFO) 210. The processor instruction may include a command, an address, and data. For example, the processor instruction may include a write request command, a write request address, and write request data. In another example, the processor instruction may include a read request and a read request address. The RX FIFO 210 may parse the processor instruction separate the command, the address, and the data, and send the command and address information to a command/address buffer (CMD/ADD Buffer) 212. In an embodiment, the RX FIFO 210 may send data included in the processor instruction to a separate data buffer (not depicted). In an embodiment, the RX FIFO 210 and the processor bus arbitrator 204 may operate asynchronously. The CMD/ADD Buffer 212 may be coupled to a memory controller 240. The CMD/ADD Buffer 212 may decode the command and address included in the processor instruction received from the RX FIFO 210.

The memory controller may be coupled to a read request address and transaction index lookup table (lookup table) 216 and an outstanding read request counter (counter) 230. The memory controller 240 may be configured to receive a read request address. The memory controller 240 may also be configured to issue an access command (e.g. read or write) to a particular memory device. For example, the memory controller may issue a read request to the RA memory 222 based on the read request address received from the lookup table 216. The memory controller 240 may be coupled to other memory devices, such as the memory devices 150, 160, and 170 of FIG. 1, or may be coupled directly to the RA memory 222.

The memory controller 240 may cause the counter 230 to increment in response to sending a read request address, such as the read request address 280, to the lookup table 216. The counter 230 may maintain a count of reads addresses received by the lookup table, and that are awaiting transmission from the lookup table 216. In an embodiment, the counter 230 is incremented by one for each read request address sent by the memory controller 240 and the counter is decremented by one for each read request address 284 sent by the lookup table 216.

The lookup table 216 may be coupled to an out-of-order (OOO) controller 220, and to the RA memory 222. The lookup table 216 may store one or more read request addresses received. In an embodiment, the lookup table 216 may be configured to store more than one read request address concurrently. For example, the lookup table 216 may store each memory locations of the RA memory 222.

The OOO controller 220 may assign a transaction index value and a simulated time delay to each read request address received by the lookup table 216. Each transaction index value may be stored in the lookup table 216. The transaction index values may be used by the processor 202 to assemble multiple read request responses returned to the processor 202 resulting from multiple read requests initiated by the processor 202. For example, the transaction index values may enable the processor 202 to reorder multiple read request response received in an order differing from an order in with the read requests were issued. In an embodiment, the algorithm used to generate the transaction index value and a data structure of the transaction value may be based on an enhanced data transaction index (EDTI) algorithm and data structure.

The transaction index value and the simulated time delay may be assigned by a transaction index state machine (state machine) 234 included in the OOO controller 220. The transaction index state machine 234 may be coupled to a simulated time delay register 236. The simulated time delay register 236 may maintain a list of simulated time delay values associated with the read requests. In an embodiment, the state machine 234 looks up a simulated time delay stored at the simulated time delay register 236 each time a new read request address 280 is received by the lookup table 216. In an embodiment, the simulated time delay register 236 may store simulated time delays based on storage locations within the lookup table 216.

The OOO controller 220 may also maintain an elapsed time timer (timer) 224 associated with each read request address 280 stored in the lookup table 216. The timer 224 may be coupled to the state machine 234, or may be included as part of the state machine 234. In an example, the timer 224 begins measuring elapsed time upon notification from the state machine 234 that a new read request address 280 has been stored in the lookup table 216. In response to the elapsed time associated with a particular transaction index value being equal to a simulated time delay, a notification may be sent to the state machine 234. In response to receiving notification that the is equal to the simulated time delay associated with a particular transaction index value, the state machine 234 may instruct the lookup table 216 to send the associated read request address to the memory controller 240.

The RA memory 222 may be coupled to an output controller 250. The RA memory 222 may be configured to receive and process an access command (e.g. read or write). For example, the RA memory 222 may receive a write request command to store the data to a particular memory address in RA memory 222. In another example, the RA memory 222 may receive a read request to retrieve and return data from a particular memory address in RA memory 222. In an embodiment, the RA memory 222 includes at least 16 addressable memory locations, each addressable memory location capable of storing at least 32 bytes.

Upon execution of an instruction, the RA memory 222 may return read/write request data to the output controller 250. The output controller 250 may also be coupled to the other memory devices. As an example, the output controller may be coupled to one or more of the DDR2 memory device 150, the serial port memory device 160, and the Ethernet memory device 170 of FIG. 1.

The output controller 250 may be coupled to the state machine 234. In an embodiment, the transaction index assignment state machine 234 returns a transaction index value. The transaction index value corresponds to an address of the register array. The memory controller 240 or the output controller 250 issues a read request to the register array address that corresponds to the transaction index returned by the out of order controller 220. The output controller 250 receives such data and passes along both transaction index and data to the TX FIFO 260 to return to the processor 202.

The output controller may combine read request data and the transaction index value for output. The output controller may be coupled to a transmission FIFO buffer (TX FIFO) 260. The TX FIFO 260 may receive the combined output 288 sent from the output controller 250. The TX FIFO 260 may be coupled to the processor bus arbitrator 204. The TX FIFO 260 may return the combined output 288 to the processor bus arbitrator 204. The processor bus arbitrator 504 may then return the combined output 288 to the processor 202. In an embodiment, the RX FIFO 210 and the processor bus arbitrator 204 are asynchronous.

The FPGA 206 may receive a cache line or burst. During a cache line read or a burst read, a series of read request instructions may be initiated by the processor 202. The FPGA 206 may act as fast memory by returning the read request data back to the processor 202 in an order in which the read requests were received from the processor 202 with no simulated time delays in the simulated time delay register 236, allowing read request instructions to be processes by the FPGA 206 in the order in which the read requests were received.

In another embodiment, the FPGA 206 may act as slow memory. For example, the simulated time delay register 236 may assign simulated time delays to each of the read requests. The time delays may allow the read request instructions to be processed in an order differing from the order in which the read request instructions were received.

For example, the RX FIFO 210 may be configured to receive a first read request instruction and a second read request instruction. In addition, the RA memory 122 may be configured to store first data at a first memory location and second data at a second memory location. Further, the lookup table 216 may be configured to store a first read request address that is mapped to the first memory location and that is associated with the first read request received from the processor 102 and a second read request address that is mapped to the second memory location and that is associated with the second read request received from the processor 102. The transaction index state machine 234, included in the OOO controller 220, may be configured to assign a first transaction index value to the first read request and a second transaction index value to the second read request.

The transaction index state machine 234 may be configured to assign a first simulated time delay to the first transaction index and a second simulated time delay to the second transaction index value. The transaction index state machine 234 may also be configured to initiate execution of the first read request in response to first elapsed time being equal to the first simulated time delay, where the first elapsed time commences upon receipt of the first read request. The state machine 234 may be further configured to initiate execution of the second read request in response to second elapsed time being equal to the second simulated time delay, where the second elapsed time commences upon receipt of the second read request.

The output controller 250 may be configured to provide, to the processor 102, a first read request response including the first data retrieved from the RA memory 222 and a second read request response including the second data retrieved from the RA memory 222. The output controller 250 may also be configured to include the first transaction index value received from the transaction index state machine 234 associated with the first read request in the first read request response and to provide the second transaction index value received from the transaction index state machine 234 and associated with the second read request in the second read request response. In embodiment, the first read request is received before the second read request and the first simulated time delay is larger than the second simulated time delay. In another particular embodiment, the second read request response is output prior to the first read request response.

The FPGA 206 may reduce testing duration and expense by simulating both fast memory types and slow memory types, as compared to completing a design, layout, and fabrication of a printed circuit board for each memory device type. Configurability of the FPGA 206 may also permit testing of different processor architectures with relatively small changes to the design of the FPGA 206.

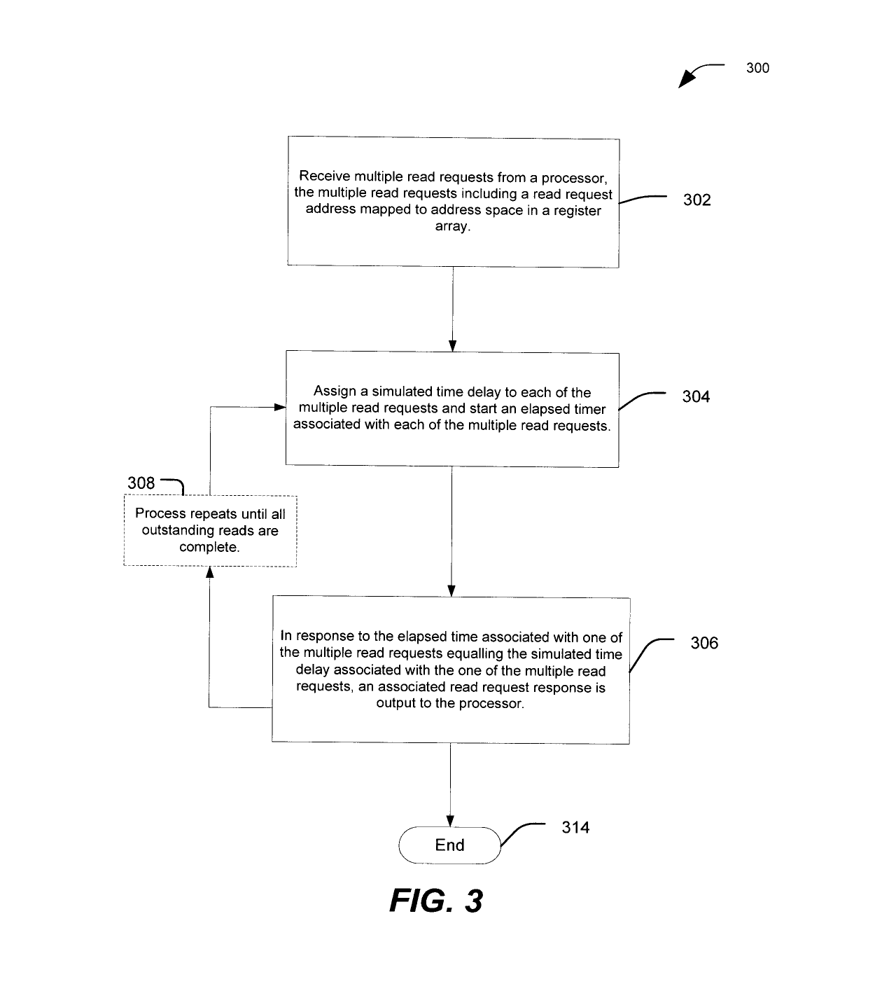

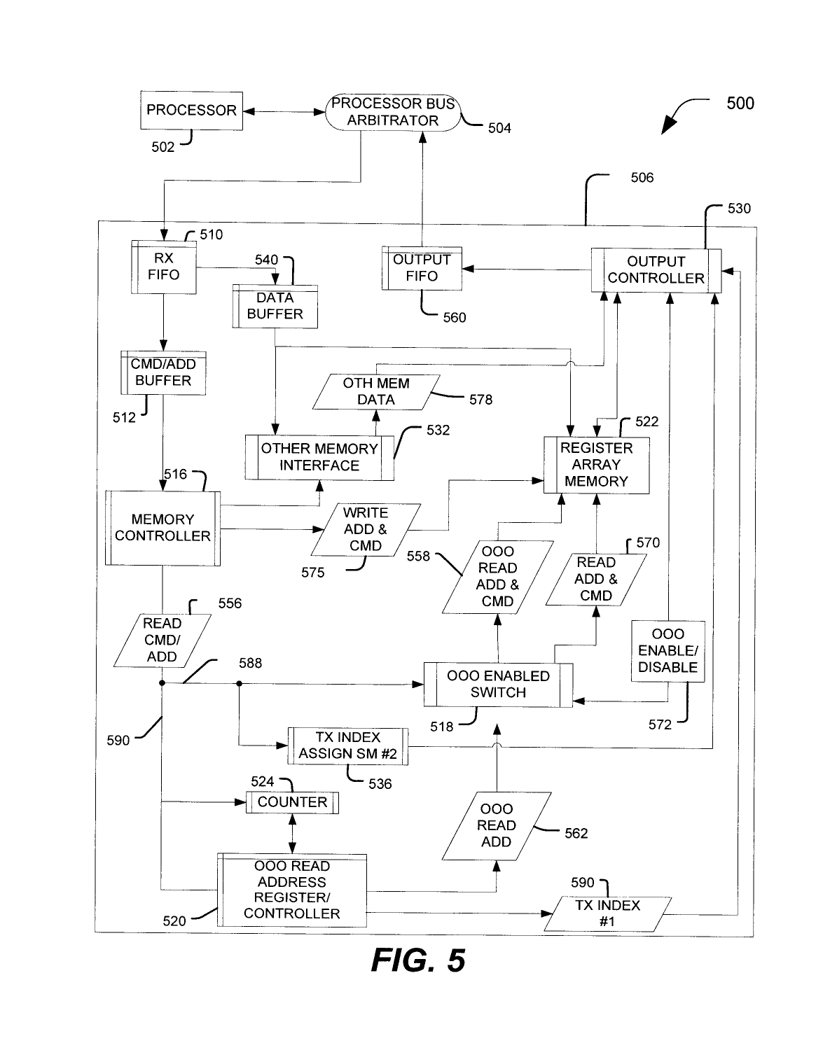

Referring to FIG. 3, a flow diagram of a first particular embodiment of a method of simulating read access to a memory by a processor is depicted and generally designated 300. The method may be performed by one or more of a computer system 100 of FIG. 1, a computer system 200 of FIG. 2, or a computer system 500 of FIG. 5.

The method includes, at 302, receiving multiple read requests from a processor, such as the processor 202 of FIG. 2. The multiple read requests may include a read request address mapped to address space in a register array, such as the RA memory 222 of the FGPA 120 of FIG. 2. For example, a first read request received from the processor includes a first read request address mapped to a first memory location of a register array, and a second read request received from the processor includes a second read request address mapped to a second memory location of the register array. In an embodiment, an outstanding reads counter, such as the outstanding reads counter 222 of FIG. 2, is incremented upon receipt of each of the multiple read requests from the processor.

At 304, assigning a simulated time delay to each of the multiple read requests, an elapsed timer associated with each of the multiple read requests is started, and an address included with each of the multiple read requests is stored in a lookup table, such as the OOO read request address register/controller 220 of FIG. 2. For example, a first simulated time delay is assigned to the first read request, a first elapsed timer starts upon receipt of the first read request at the FPGA 206, and the first read request address is stored at the OOO read request address register/controller 220 of FIG. 2, and a second simulated time delay is assigned to the second read request, a second elapsed timer starts upon receipt of the second read request at the FPGA 206 of FIG. 2, and the second read request address is stored at the OOO read request address register/controller 220 of FIG. 2. The first read request may be received prior to the second read request. In an embodiment the first simulated time delay is larger than the second simulated time delay.

At 306, in response to the elapsed time associated with one of the multiple read requests equals the simulated time delay associated with the one of the multiple read requests, an associated read request response is output to the processor. In an embodiment, the read response request includes data retrieved from a register array memory address included in the one of the multiple read requests. For example, when the first elapsed timer equals the first simulated time delay, a first read request response is output, where first read request response includes first data stored in the first memory location, and when the second elapsed timer equals the second simulated time delay, a second read request response is output, where second read request response includes second data stored in the second memory location.

The read request response may include an associated transaction index value, such as a first transaction index value with the first read request response and a second transaction index value with the second read request response. The transaction index value may be based on an enhanced data transaction index (EDTI). In an embodiment, the second read request response may be output prior to the first read request response. In another embodiment, the outstanding reads counter is decremented by one in response to each output associated with the multiple read requests.

At 308, the process may continue until all outstanding reads requests have been output. In an embodiment, the process continues until the outstanding reads counter is equal to zero.

The method 300 may enable simulation of multiple memory devices having a wide variance in timing and latency characteristics. The method may also enable simulation of returning data from memory in a modified order differing from a chronological order in which the data is requested. The configurable timing parameters may allow a single implementation of the FPGA 206 to be used to test distinct processor architectures.

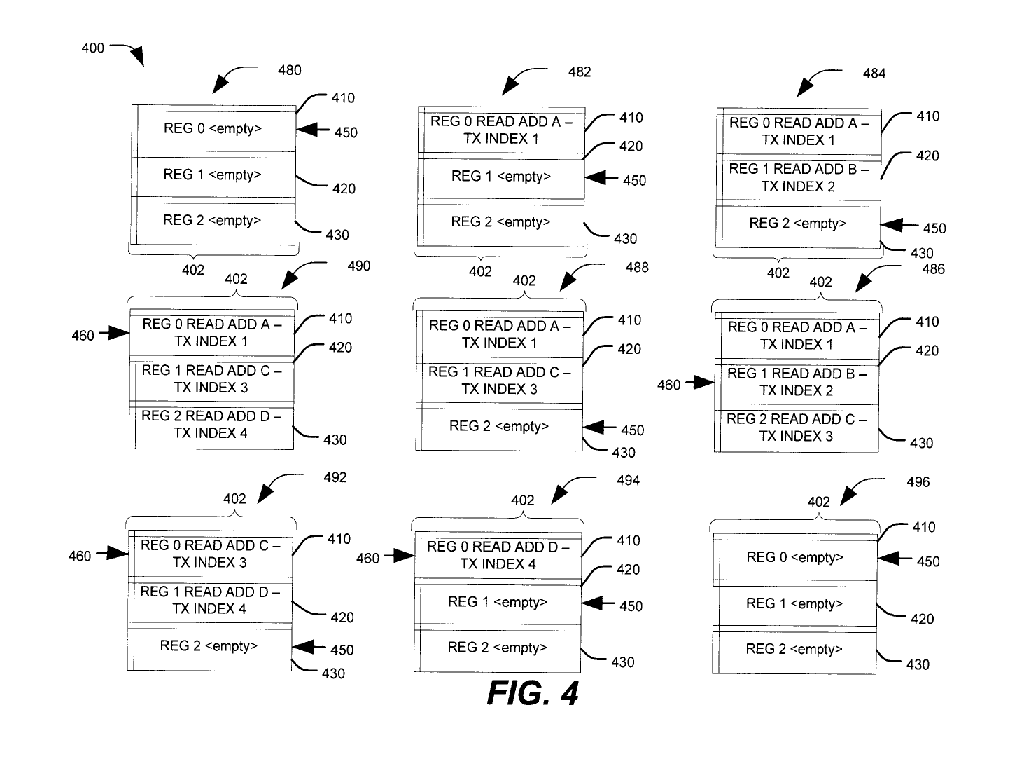

Referring to FIG. 4, a lookup table storing read request addresses in locations each associated with a transaction index value is depicted. A read request address and transaction index lookup table (lookup table) 402 may correspond to the lookup table 216 of FIG. 2. In the embodiment shown in FIG. 4, the lookup table 402 includes three storage locations, register 410, register 420, and register 430. Other embodiments may include more or less storage locations.

At initial stage 480, registers 410, 420, and 430 are empty (i.e. are not storing data). Moving to stage 482, a read request address A, having an associated transaction index 1, is stored in register 410, which is a first available storage location of the lookup table 402. The first available storage location may be indicated by a write pointer 450. After the read request address A is stored in register 410, the write pointer 450 may indicate register 420 is the next available storage location. Proceeding to stage 484, read request address B, having associated transaction index 2, is stored in register 420 of the lookup table 402. Read request address B is stored in the next available storage location as identified by the write pointer 450.

At stage 486, read request address C, having associated transaction index 3, is stored in register 430 of the lookup table 402. The next available storage location is identified by the write pointer 450. Proceeding to stage 488, a request to send read request address B is received (e.g. received from an out-of-order (OOO) controller, such as the OOO controller 220 depicted in FIG. 2). The read request address B is extracted from register 420 and sent (e.g. to a register array memory, such as the RA memory 222 of FIG. 2). A read pointer 460 may be implemented to indicate an appropriate storage location from which to extract a read request address. In an embodiment, register entries stored in registers following the emptied register may shift up one register to fill the emptied register. For example, at stage 488, register 420 stores read request address C, and register 430 is empty. The write pointer may be decremented by one register location in response to extraction of the read request address B. For example, the write pointer may now indicate register 430 is the next available storage location in which to write another read request address.

Moving to stage 490, read request address D, having associated transaction index 4, is stored in register 430 of the lookup table 402. The next available storage location is identified by the write pointer 450. Proceeding to stage 492, a request to send read request address A is received. The read request address A is extracted from register 410 and sent. The read pointer 460 may indicate an appropriate storage location from which to extract a read request address. The register entries stored in registers following the emptied register may shift up one register to fill the emptied register. For example, at stage 492, register 410 stores read request address C, register 420 stores read request address D, and register 430 is empty. The write pointer may be decremented by one register location in response to extraction of the read request address A. For example, the write pointer may now indicate register 430 is the next available storage location in which to write another read request address.

Proceeding to stage 494, a request to send read request address C is received. The read request address C is extracted from register 410 and sent. The read pointer 460 may indicate an appropriate storage location from which to extract a read request address. The register entries stored in registers following the emptied register may shift up one register to fill the emptied register. For example, at stage 494, register 410 stores read request address D, and registers 420 and 430 are empty. The write pointer may be decremented by one register location in response to extraction of the read request address C. For example, the write pointer may now indicate register 420 is the next available storage location in which to write another read request address.

Proceeding to stage 496, a request to send read request address D is received. The read request address D is extracted from register 410 and sent. The read pointer 460 may indicate an appropriate storage location from which to extract a read request address. The register entries stored in registers following the emptied register may shift up one register to fill the emptied register. For example, at stage 496, registers 410, 420, and 430 all are empty. The write pointer may be decremented by one register location in response to extraction of the read request address C. For example, the write pointer may now indicate register 410 is the next available storage location in which to write another read request address.

The method 400 may allow a series of read request instructions initiated by a processor to be maintained, and returned in an order other than the order in which the read request instructions were received. The method 400, when used in conjunction with an OOO controller, such as the OOO controller 220 of FIG. 2, may allow testing of latency and timing characteristics associated with one or more memory devices. The ability to test processor functionality with one or more memory devices provides a faster and cheaper alternative to designing, laying out, and fabricated a separate printed circuit board for each distinct memory device.

Referring to FIG. 5, a block diagram of the first particular embodiment of a computer system 500, includes a field programmable gate array (FPGA) 120 configured to simulate memory access by a processor 502. The processor 502 is coupled to a processor bus arbitrator 504. The processor bus arbitrator 504 is coupled to the FPGA 506. The processor bus arbitrator 504 sends and receives data and instructions from the processor 502, and sends and receives data from the FPGA 506. The processor 502 may correspond to the processor 102 of FIG. 1 and/or the processor 202 of FIG. 2. The processor bus arbitrator 504 may correspond to process bus arbitrator of FIG. 2. The FPGA 506 may correspond to the FPGA 106 of FIG. 1 and FPGA 206 of FIG. 2.

The FPGA 506 may receive a processor instruction from the processor bus arbitrator 504 into a receive first-in-first-out (FIFO) buffer (RX FIFO) 510. The processor instruction 550 may include a memory access instruction that may include one or more of a command, an address, and a data. The RX FIFO 510 may be coupled to a command/address buffer (CMD/ADD Buffer) 512 and a data buffer 540. The RX FIFO 510 may parse the processor instruction into a data portion, an address and a command portion. In an embodiment, the RX FIFO 510 is configured to send the data portion to the data buffer 540. The data buffer 540 may be configured to send the data portion to the register array (RA) memory 522 and an external other memory interface 532. The RA memory 522 may correspond to the RA memory 122 of FIG. 1 and the RA memory 222 of FIG. 2.

The RX FIFO 510 may be configured to send the address and command portion of the processor instruction to the command/address buffer 552. The CMD/ADD Buffer 512 may be coupled to a memory controller 516. The CMD/ADD Buffer 512 may be configured to decode the address and the command portion received from the RX FIFO 510. In an embodiment, the CMD/ADD Buffer 512 may be separate buffers, one for address data and one for command data.

The memory controller 516 may be coupled to one or more memory devices. For example, the memory controller 516 may be coupled to the RA memory 522. The memory controller 516 may also be coupled to other memory interfaces 532 (e.g. interfaces associated with the memory devices 150, 160, and 170 of FIG. 1). The memory controller may also include a synchronization function to sync timing with the other memory devices. The memory controller 516 may issue a write command to one of the memory devices. For example, the memory controller may issue a write command to RA memory 522 or other external memory devices via the other memory external memory interface 532. The write command may include the write request command and a write request address. The data to be written may be received at the memory device via the data buffer 540. In another embodiment, the memory controller may send the write data. For example, if the memory controller 516 determines the address and command information portion of the processor instruction includes is a write request for a memory address in RA memory 522, the write request address and command information may be sent to RA memory 522.

In an embodiment, the memory controller 516 output of read request address data is sent along a first path 588 and is sent along a second path 590. The first path 588 and the second path 590 may converge at an OOO enabled switch 518. The first path 588 may be coupled to an OOO enabled switch 518 and a transaction index state machine (state machine) 536. In an embodiment, the state machine 536 maintains an index of read request addresses commands received from the processor 502 along first path 588, such as an enhanced data transaction index (EDTI).

The second path 590 may couple to an OOO read request address register/controller (OOO controller) 520 and to an outstanding reads counter (counter) 524. The counter 524 may include an interface with the OOO controller 520. In an embodiment, the counter 524 maintains a count of outstanding read requests designated for the RA memory 522 to be sent from the OOO controller 520. For example, when a read request address/command 556 is received along the second path 590, the counter 524 is incremented by one, and when the OOO controller 520 sends OOO read request address and command information (OOO information) 562, the counter 524 is decremented by one.

The OOO controller 520 may be coupled to the OOO enabled switch 518. The OOO controller 520 may correspond to a combination of the OOO controller 220, the simulated time delay register 236, and the lookup table 216, all of FIG. 2. In an embodiment, OOO controller maintains an index of read instruction commands received from the processor 502 by the OOO controller 520. The OOO controller 520 may be configured to communicate a transaction index value 590, corresponding to an OOO information 562, to an output controller 524.

The OOO controller 520 may receive and store a read request address included in the read request address/command 556. In an embodiment, the OOO controller 520 may be configured to store more than one read request address concurrently. For example, the OOO controller 520 may store up to a number of read request addresses corresponding to the number memory locations of the RA memory 522.

Upon receipt of the new read request address at the OOO controller 520, a simulated delay time is associated with the new read request address by the OOO controller 520, and an elapsed timer is started. The simulated delay time may be predetermined based on the initial storage location within the OOO controller 520. In an embodiment, each read request address received by the OOO controller 520 is stored consecutively in a next available register location. In response to an elapsed timer associated with a read request address equaling the simulated time delay associated with the read request address, the OOO controller 520 sends the OOO information 562 to the OOO enabled switch 518. In an embodiment, the OOO controller 520 may send a second read request address, that was received by the FPGA 506 and the OOO controller 520 after receiving a first read request address and prior to sending the first read request address in the OOO information 562.

The OOO enabled switch 518 may be coupled to the RA memory 522 and to an OOO enable/disable selector 572. The OOO enable/disable selector 572 may selectively enable or disable the OOO function. In an embodiment, when the OOO enable/disable selector 572 is set to enabled, the OOO enable/disable selector 572 is prohibited from changing to disabled while the counter 524 is greater than zero.

In an embodiment, when the OOO enable/disable selector 572 is set to enable, the OOO enabled switch 518, passes OOO read request address and command information 558 to the RA memory 522. Alternatively, when the OOO enable/disable selector 572 is set to disable, the OOO enabled switch 518 passes read request address and command information 570 to the RA memory 522.

The RA memory 522 may be coupled to an output controller 524. The RA memory 522 may be configured to receive and process memory access instructions, i.e. read requests and write requests. For example, the RA memory 522 may use the write address and command information 575, in conjunction with data from the data buffer 540, to store the data to an address included in the write address and command information 575. In another example, the RA memory 522 may use the read request address and command information 570 (or the OOO read request address and command information 558) to retrieve data from an address included in the read request address and command information 570 (or the OOO read request address and command information 558).

Upon execution of an instruction, the RA memory 522 sends read/write request response data to the output controller 530. The output controller 530 may also be coupled to the other memory interface 532, and may also be configured to receive other memory data 578. It is understood that the other memory interface may also include other memory devices not disclosed.

The output controller 530 may also be coupled to a transmission FIFO buffer (TX FIFO) 560. In an embodiment, the output controller 530 determines data to be sent to the TX FIFO 560. For example, when data processed along the first path 588 is to be sent, the output controller 530 sends the data retrieved from RA memory 522 and an associated transaction index value obtained from the state machine 536. In another example, when data processed along the second path 590 is to be sent, the output controller 524 sends the data retrieved from RA memory 522 and an associated transaction index value obtained from the OOO controller 520. In another example, when data processed from the other network interface 532 is to be sent, the output controller 524 sends data and a transaction index value received from the other network interface 532.

The TX FIFO 560 is coupled to the processor bus arbitrator 504. The TX FIFO 560 sends data and transaction index information to the processor bus arbitrator 504. The processor bus arbitrator 504 returns the data and transaction index value to the processor 502.

The FPGA 506 may receive full cache line or burst reads to RA memory 522. During a full cache line read or a burst read, a series read request instructions may be received from the processor 502. When the OOO enable/disable selector 572 is set to disable, the is FPGA 506 may act as fast memory, returning the full cache line read request data (or the burst read data) back to the processor in the order the series of read requests were received from the processor 502. When the OOO enable/disable selector 572 is set to enable, the FPGA 506 may act as slow memory. For example, the OOO function may include assigning a uniform simulated time delay in executing each of the full cache line read request instructions (or the burst read request instructions) until the assigned simulated time delay for a read request has expired. The OOO function may also be configured to cause each of a series of read requests to be executed in an order different from the order of receipt by the FPGA 506 by assigning varied simulated time delays to each read request in the series of read requests. The FPGA may also be configured to process write requests to the RA memory 522 to populate addresses within the RA memory with data received from the data buffer 540.

The FPGA 506 may result in reduced testing duration and expense by simulating both fast memory types and slow memory types in lieu of completing a design, layout, and fabrication of a printed circuit board for each memory type. The configurability of FPGA 506 may also allow testing of many different processor architectures by making relatively small changes to the design of the FPGA 506.

Although FIG. 5 depicts the FPGA 506 configured to process write request instructions, simulate fast memory via the first path 588, simulate slow memory via the second path 590, and communicate with external devices via the other memory interface 532, other embodiments of the FPGA 506 may be configured to include a subset of these functions. For example, a second embodiment of the FPGA 506 may be configured to only process write requests to RA memory 522. A third embodiment of FPGA 506 may be limited to processing read request instructions as depicted along the second path 590. Alternatively, the FPGA 506 may also be configured to include functions other than those depicted in FIG. 5.

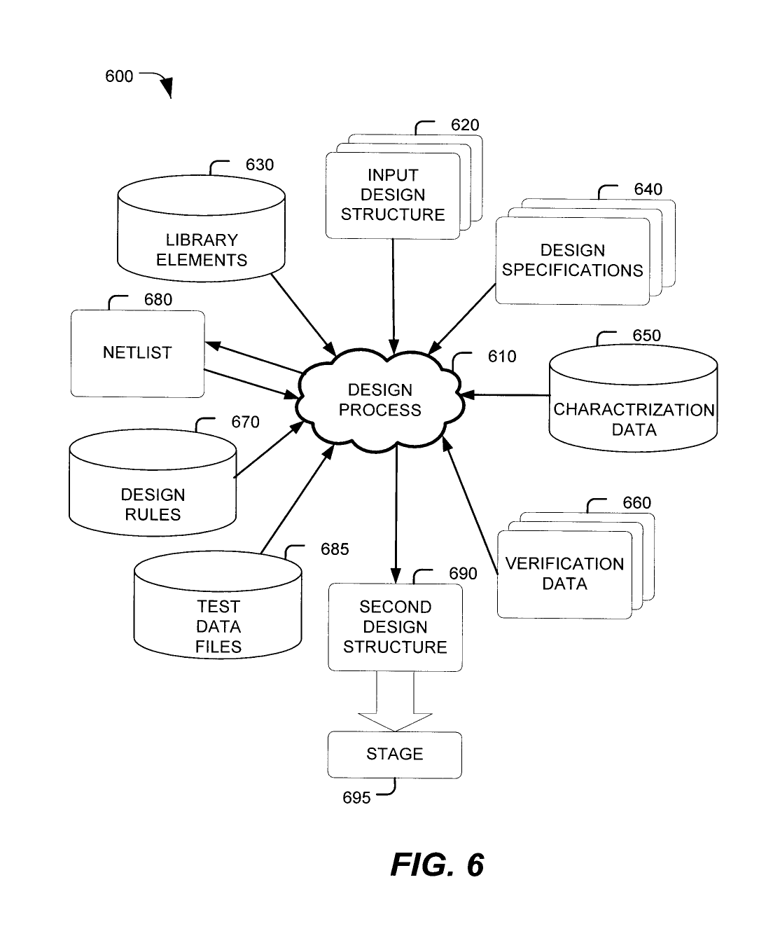

FIG. 6 shows a block diagram of an exemplary design flow 600 used for example, in semiconductor IC logic design, simulation, test, layout, and manufacture. Design flow 600 includes processes, machines and/or mechanisms for processing design structures or devices to generate logically or otherwise functionally equivalent representations of the design structures and/or devices described above and shown in FIGS. 1, 2, and 5. The design structures processed and/or generated by design flow 600 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 600 may vary depending on the type of representation being designed. For example, a design flow 600 for building an application specific IC (ASIC) may differ from a design flow 600 for designing a standard component or from a design flow 600 for instantiating the design into a programmable array, for example a programmable gate array (PGA) or a field programmable gate array (FPGA) offered by Altera® Inc. or Xilinx® Inc.

FIG. 6 illustrates multiple such design structures including an input design structure 620 that is preferably processed by a design process 610. Design structure 620 may be a logical simulation design structure generated and processed by design process 610 to produce a logically equivalent functional representation of a hardware device. Design structure 620 may also or alternatively comprise data and/or program instructions that when processed by design process 610, generate a functional representation of the physical structure of a hardware device. Whether representing functional and/or structural design features, design structure 620 may be generated using electronic computer-aided design (BCAD) such as implemented by a core developer/designer. When encoded on a machine-readable data transmission, gate array, or storage medium, design structure 620 may be accessed and processed by one or more hardware and/or software modules within design process 610 to simulate or otherwise functionally represent an electronic component, circuit, electronic or logic module, apparatus, device, or system such as those shown in FIGS. 1, 2, and 5. As such, design structure 620 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 610 preferably employs and incorporates hardware and/or software modules for synthesizing, translating, or otherwise processing a design/simulation functional equivalent of the components, circuits, devices, or logic structures shown in FIGS. 1, 2, and 5 to generate a Netlist 680 which may contain design structures such as design structure 620. The Netlist 680 may comprise, for example, compiled or otherwise processed data structures representing a list of wires, discrete components, logic gates, control circuits, I/O devices, models, etc. that describes the connections to other elements and circuits in an integrated circuit design. The Netlist 680 may be synthesized using an iterative process in which the Netlist 680 is re-synthesized one or more times depending on design specifications and parameters for the device. As with other design structure types described herein, the Netlist 680 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 610 may include hardware and software modules for processing a variety of input data structure types including the Netlist 680. Such data structure types may reside, for example, within library elements 630 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 640, characterization data 650, verification data 660, design rules 670, and test data files 685 which may include input test patterns, output test results, and other testing information. Design process 610 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 610 without deviating from the scope and spirit of the invention. Design process 610 may also include modules for performing standard circuit design processes such as timing analysis, verification, design rule checking, place and route operations, etc.

Design process 610 employs and incorporates logic and physical design tools such as HDL compilers and simulation model build tools to process design structure 620 together with some or all of the depicted supporting data structures along with any additional mechanical design or data (if applicable), to generate a second design structure 690. Design structure 690 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 620, design structure 690 preferably comprises one or more files, data structures, or other computer-encoded data or instructions that reside on transmission or data storage media and that when processed by an ECAD system generate a logically or otherwise functionally equivalent form of one or more of the embodiments shown in FIGS. 1, 2, and 5. In one embodiment, design structure 690 may comprise a compiled, executable HDL simulation model that functionally simulates the devices shown in FIGS. 1, 2, and 5.

Design structure 690 may also employ a data format used for the exchange of layout data of integrated circuits and/or symbolic data format (e.g. information stored in a GDSII (GDS2), GLI, OASIS, map files, or any other suitable format for storing such design data structures). Design structure 690 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1, 2, and 5. Design structure 690 may then proceed to a stage 695 where, for example, design structure 690: proceeds to tape-out, is released to manufacturing, is released to a mask house, is sent to another design house, is sent back to the customer, etc.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiments disclosed, but that the invention will include all embodiments falling within the scope of the apportioned claims. Moreover, unless specifically stated any use of the terms first, second, etc. do not denote any order or importance, but rather the terms first, second, etc. are used to distinguish one element from another.

As will be appreciated by one skilled in the art, aspects of the present disclosure may be embodied as a system, a method, a computer program product, or in other manners. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “logic,” “module,” or “system.” Furthermore, aspects of the present disclosure may take the form of a computer program product embodied in one or more computer readable medium(s) having computer-readable program code embodied thereon.

Any combination of one or more computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain, or store a program for use by or in connection with an instruction performing system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction performing system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JAVA (JAVA is a registered trademark of Sun Microsystems), Smalltalk, C++ or the like and conventional procedural programming languages, such as the “C” programming language or similar programming languages. The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which perform via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which perform on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more performable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. Example embodiments may be performed with or without query processing.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
receiving a first read request from a processor, the first read request comprising a first read request address mapped to a first memory location of a register array;
receiving a second read request from the processor, the second read request comprising a second read request address mapped to a second memory location of the register array;
assigning a first simulated time delay to the first read request and assigning a second simulated time delay to the second read request;
in response to a first elapsed time being equal to the first simulated time delay, outputting a first read request response, wherein the first read request response comprises first data stored at the first memory location, and wherein the first elapsed time commences upon receipt of the first read request; and
in response to a second elapsed time being equal to the second simulated time delay, outputting a second read request response, wherein the second read request response comprises second data stored at the second memory location, and wherein the second elapsed time commences upon receipt of the second read request.

2. The method of claim 1, wherein the first read request is received before the second read request is received and, wherein the first simulated time delay is smaller the second simulated time delay.

3. The method of claim 1, wherein outputting the second read request response occurs prior to outputting the first read request response, wherein the first simulated time delay is larger than the second simulated time delay.

4. The method of claim 1, further comprising:
associating a first read request identifier with the first read request; and
associating a second read request identifier with the second read request.

5. The method of claim 4, wherein the first read request response further comprises the first read request transaction index value, and wherein the second read request response further comprises the second read request transaction index value.

6. The method of claim 1, further comprising:
retrieving the first data from the first memory location of the register array; and
retrieving the second data from the second memory location of the register array.

7. The method of claim 1, further comprising maintaining an outstanding read request counter;
wherein the outstanding read request counter is incremented in response to receiving each of the first read request and the second read request; and
wherein the outstanding read request counter is decremented in response to outputting each of the first read request response and the second read request response.

8. A semiconductor device comprising:
a receive first-in-first-out (FIFO) buffer, the FIFO buffer configured to receive instructions from a processor;
a register array memory, the register array memory configured to store first data at a first memory location and to store second data at a second memory location;
a read request address register, the read request address register configured to:
store a first read request address that is mapped to the first memory location and that is associated with a first read request received from the processor; and
store a second read request address that is mapped to the second memory location and that is associated with a second read request received from the processor;
an out-of-order controller, the out-of-order controller configured to:
assign a first simulated time delay to the first read request; and
assign a second simulated time delay to the second read request;
initiate execution of the first read request in response to first elapsed time being equal to the first simulated time delay, wherein the first elapsed time commences upon receipt of the first read request; and
initiate execution of the second read request in response to second elapsed time being equal to the second simulated time delay, wherein the second elapsed time commences upon receipt of the second read request; and
an output controller configured to:
provide, to the processor, a first read request response, wherein the first read request response includes the first data; and
provide, for output to the processor, a second read request response, wherein the second read request response includes the second data.

9. The semiconductor device of claim 8, wherein the first read request is received before the second read request is received and, wherein the first simulated time delay is larger than the second simulated time delay.

10. The semiconductor device of claim 9, wherein the second read request response is provided to the processor prior to the first read request response.

11. The semiconductor device of claim 9, further comprising a memory controller, wherein the memory controller controls access to the register array memory.

12. The semiconductor device of claim 9, wherein the first simulated time delay and the second simulated time delay are assigned based on a data read latency characteristic associated with double data rate synchronous dynamic random-access memory.

13. The semiconductor device of claim 9 further comprising a command buffer, the command buffer configured to extracts a command and an address included in each processor instruction.

14. The semiconductor device of claim 9 further comprising a data buffer, the data buffer configured to extract a data included in each processor instruction.

15. The semiconductor device of claim 9, wherein the semiconductor device is a field programmable gate array.

16. The semiconductor device of claim 9, wherein the out-of-order controller is further configured to:
associate a first read request identifier with the first read request; and
associate a second read request identifier with the second read request.

17. A computer-readable storage medium comprising operational instructions that, when executed by a processor, cause the processor to:
receive a first read request from a processor, the first read request comprising a first read request address mapped to a first memory location of a register array;
receive a second read request from the processor, the second read request comprising a second read request address mapped to a second memory location of the register array;
assign a first simulated time delay to the first read request and assign a second simulated time delay to the second read request;
in response to a first elapsed time being equal to the first simulated time delay, output a first read request response, wherein the first read request response comprises first data stored at the first memory location, wherein the first elapsed time commences upon receipt of the first read request; and
in response to a second elapsed time being equal to the second simulated time delay, output a second read request response, wherein the second read request response comprises second data stored at the second memory location, wherein the second elapsed time commences upon receipt of the second read request.

18. The computer-readable storage medium of claim 17, wherein the first read request is received before the second read request is received and, wherein the first simulated time delay is larger than the second simulated time delay.

19. The computer-readable storage medium of claim 18, wherein the second read request response is output prior to the first read request response.

20. The computer-readable storage medium of claim 17, wherein the operational instructions are executed by the processor to:
associate a first read request identifier with the first read request; and
associate a second read request identifier with the second read request.
